(19) United States
(12) Patent Application Publication
(10) Pub. No.: US 2005/0169702 A1
(43) Pub. Date: Aug. 4, 2005

(54) End termination means in a tension leg and a coupling for use between such an end termination and connecting point

(76) Inventor: Bjorn Paulshus, Skedsmokorset (NO)

Correspondence Address: BIRCH STEWART KOLASCH & BIRCH, PO BOX 747, FALLS CHURCH, VA, 22040-0747, US

(21) Appl. No.: 10/501,482

(22) PCT Filed: Jan. 22, 2003
(86) PCT No.: PCT/NO03/00019

(30) Foreign Application Priority Data
Jan. 25, 2002 (NO) 20020406

(51) Int. Cl. F16D 1/00

(52) U.S. Cl. 403/300

(57) ABSTRACT

An end termination means for tension legs (10) of non-metallic materials like composite material is disclosed. The tension leg (10) is constructed of a number of strands (5) that constitute the load carrying elements of the tension leg (10). The strands (5) are twisted (laid) about the longitudinal axis of the tension leg (10) by a predetermined laying length and each strand (5) is in turn constructed of a plurality of rods (7) of composite material having embedded strength fibers. The rods (7) are in turn twisted about each other like in a wire rope. The strands (5) terminate near a receiving body (16) having connecting means and a number of through-going apertures enclosing the respective strands. Each strand (5) is passed through respective aperture (8) in the receiving body (16) without being fixed therein.

The present invention relates to an end termination means for tension legs of non-metallic materials like composite material, which tension leg is constructed of a number of strands that constitute the load carrying elements of the tension leg, which strands are twisted (laid) about the longitudinal axis of the tension leg by a predetermined laying length and each strand is in turn constructed of a plurality of rods of composite material having embedded strength fibres where the rods are twisted about each other like in a wire rope, and the strands terminate near a receiving body having connecting means and a number of through-going apertures enclosing the respective strands.

Tension legs of the above described nature are known from NO 20002812. An end termination means is known from NO 20002811. An end termination means is also described in WO 02/057560 with the same applicant as to the present invention.

The end termination according to the invention is in particular developed in view of tension legs that anchor a tension leg platform. Other uses, however, are also of interest, e.i. vertical stays of suspension bridges and similar stays that need to be able to transfer heavy axial forces/loads.

The advantages with tension legs of composite material is low weight, great load carrying capacity in regard of weight/volume, substantially less prone for fatigue, which means that there is no need for bending restrictors, in addition to be very competitive regarding price/cost. Moreover they have the excellent quality of being able to be coiled onto reels having diameter down to 4 meters.

Tension legs of steel find their limitation in regard of longitudinal extension, i.e. depths of the ocean, because tension legs are designed as tubulars or pipes in order to reduce the weight in water, preferably so that the tension legs become next to “weightless” when submerged in water. At greater depths it is necessary to increase the wall thickness to avoid buckling due to the external water pressure.

The later solutions with tension legs of composite material are also considered used when an existing tension leg platform, which is anchored by tethers of steel, is to be transferred to deeper waters. The steel tethers can then be cut off and replaced with tension legs of composite material.

Of particular concern when composite material is used to transfer forces in load carrying elements, is that the main stresses extend axially within the load carrying elements and that shear stresses should hardly appear.

With the solution shown in NO 20006643 each strand terminates within a receiving body. In order to fix the strands in a secure manner within the receiving body, it was proposed to make conical inclined apertures in the receiving body. It has now been recognised that the working process for making such apertures are very complicated and expensive.

Additionally, it has been a desire to provide a certain degree of motional freedom to the terminating area of the strands. During reeling of the tension leg, primarily for transportation purposes, a mutual displacement between the strands will take place. This results in that some of the strands tend to be retracted into the tension leg, while others will be pushed out at the end termination. This may provide undue compression stress within the composite material for those strands being pushed out if this motion is prevented.

It is also desired with a certain motional freedom with regard to direction. This is substantiated from the dynamic loading that the tension legs are exposed to when installed. During altering tensile stresses in the tension leg, the tension leg tends to twist about its own longitudinal axis. Thus each individual strand tends to change direction, though it is to be understood that we speak of small angular deviations.

According to the present invention the above mentioned conditions are taken care of by a means of the introductorily described type, which is distinguished by that each strand is passed through respective aperture in the receiving body without being fixed therein, that each strand has a free end terminating some distance above the receiving body, and that the free end of each strand is fixed to and enclosed by a terminating sleeve having a diameter larger than a corresponding aperture in the receiving body, which terminating sleeve is loosely resting on or abutting the receiving body.

In order to obtain secure anchoring of the strands, the terminating sleeve is preferably internally tapered in a direction towards the receiving body.

In order to take care of the motion of the individual strands within the receiving body, a guiding sleeve is suitably arranged in each aperture of the receiving body. Preferably the guiding sleeve is shorter than the length of the aperture in the receiving body. In a preferable embodiment, each guiding sleeve is provided near the entry of the strand into an aperture of the receiving body.

In order that the terminating sleeve is to return to the same resting surface on the receiving body, each aperture through the receiving body may preferably terminate in a concentric recess for receipt of and to act as a guide and seat for the terminating sleeve.

In a preferable embodiment the end termination means may include an embracing element that is spaced apart from the receiving body and keeps the strands together. Between the embracing element and the receiving body the strands extend less radial restriction and in a substantially natural direction towards and into the apertures of the receiving body.

By “natural direction” is the following meant. Up to the embracing element the tension leg extends as a compact string having twisted (laid) strands that are kept together by means of an outer sheath. From the embracing element and further up to the receiving body, the outer sheath is removed. If one temporarily disregards the receiving body, the strands will, when passing out from the embracing element, adopt a natural direction. This natural direction implies that the twisted configuration discontinues and transforms into a rectilinear configuration. The direction of each individual strand, however, will extend obliquely with respect to the longitudinal axis of the tension leg. Expressed in a different way, the strands continue toward the receiving body by a direction extending tangential to helical line of the strands in the tension leg. And, to be noticed, in addition to this oblique direction, the strands will moreover simultaneously diverge from the longitudinal axis of the tension leg. This direction of the strands is adopted quite natural as a consequence to that the restriction ceases at a particular place.

This recognition was exploited to avoid the introduction of shear stresses in the stands. The apertures in the receiving body are placed at such radial distance from the longitudinal axis of the tension leg that they correspond with the divergence of the strands at the same time as they are adapted to their inclined direction and rotational orientation.

Examples of embedded strength fibres that can be used as rods in the strands are fibres of carbon, kevlar, glass or aramid.

In a preferable embodiment the apertures in the receiving body can be somewhat inclined relative to the longitudinal axis of the tension leg, and preferably the inclination corresponds with the natural direction of the strands between the embracing element and the terminating sleeves.

The end termination may preferably include an external rigid sleeve that is fixed in one end thereof to the receiving body and in the other end to the embracing element.

For further connection, the receiving body can have at least one annular groove provided on the outer surface thereof for engagement with at least one first annular rib on a connecting part interconnected to an anchor point.

Further the anchor point can have at least one external annular groove for engagement with at least one second annular rib provided on the connecting part a distance apart from the at least one first rib, which connecting part is radially fixed by a surrounding connecting part.

According to the present invention, also a coupling for use between an end termination and an anchor point as described above is provided, which coupling is distinguished in that the radially outer surface of the connecting part has an upwards directed conical form and the radially inner surface of the surrounding connecting part has a complementary conical form.

Conveniently the connecting part can include pin bolts for temporary fixation of the connecting part to the anchor point.

Other and further objects, features and advantages will appear from the following description of one for the time being preferred embodiment of the invention, which is given for the purpose of description, without thereby being limiting, and given in context with the appended drawings where:

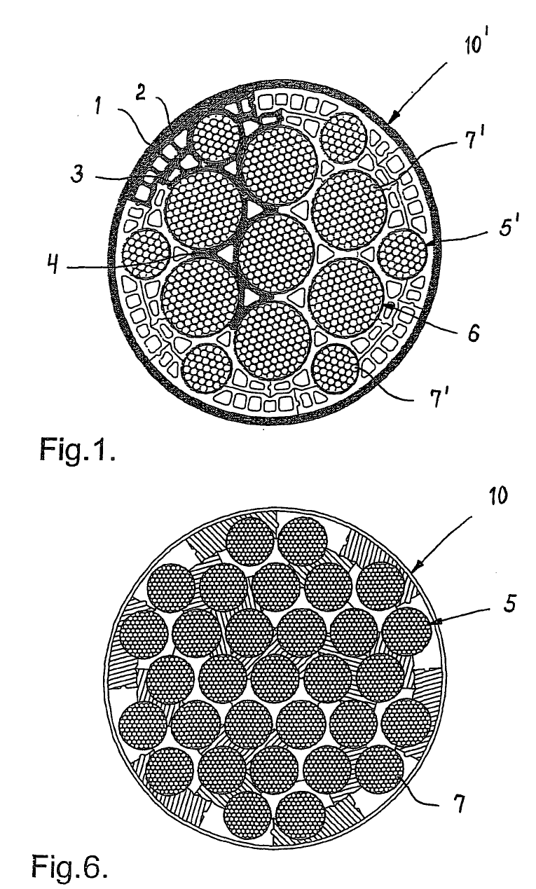

FIG. 1 shows a cross sectional view of a typical tension leg for use with the present invention,

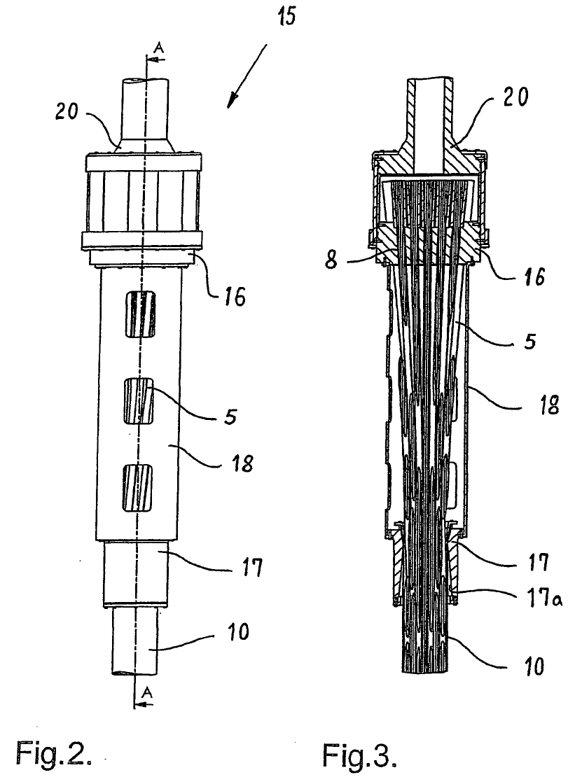

FIG. 2 shows a side elevation view of the end termination according to the invention,

FIG. 3 shows longitudinal sectional view of the end termination along line A-A in FIG. 2,

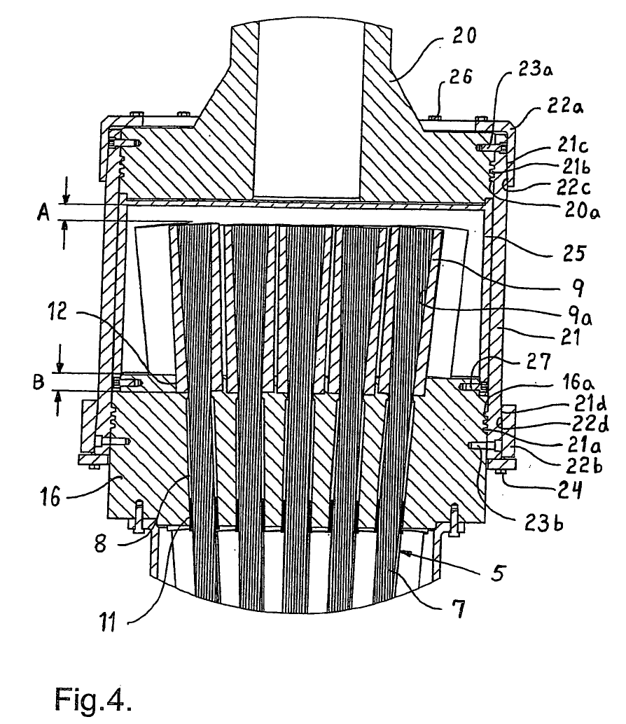

FIG. 4 shows in closer detail an end termination means according to the invention,

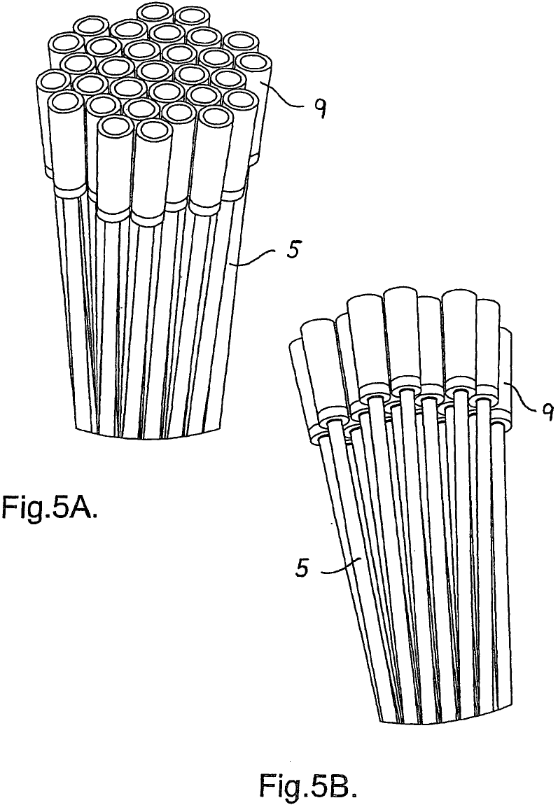

FIG. 5A shows in detail from above, how the strands in the tension leg terminate within the end termination means when free-standing,

FIG. 5B shows in detail, from below, how the strands in the tension leg terminate within the end termination means when free-standing, and

FIG. 6 shows another sectional view of a tension leg for use with the present invention.

Reference is first made to FIG. 1 that illustrates an example of how a tension leg 10′ of this nature normally is constructed. The tension leg 10′ has an enclosing and gathering sheath 1 of a heavy duty and resistant material, such as polyethylene. Spacer elements in form of different profiles in several layers are arranged within the sheath 1, first an outer profile 2, next an intermediate profile 3 and then an inner profile 4. These profiles have no load carrying properties and only act as spacing elements. They may, as an example, be manufactured of PVC. The profiles 2, 3, 4 create between them cavities that receive respective strands 5′, 6, which are the load carrying elements in the tension leg 10′. Each strand 5′, 6 is in turn constructed of a number of rods 7′, which are manufactured of a composite material having embedded strength fibres. The figure shows strands 5′, 6 of different dimensions. Each of the seven strands 5′ is made up of 85 rods 7′ and each of the six strands 6 is made up of 31 rods 7′.

It is the individual rods 7′ within the stands 5′, 6 that transfer the forces/loads within the tension leg 10′. The embedded strength fibres may be fibres of carbon, kevlar, glass or aramid.

Reference is now made to FIG. 6 that illustrates a second embodiment of a tension leg 10 that is in particular developed for use with the present end termination 15. Here, all the strands 5 are of same dimension and the tension leg 10 is constructed as a bundle consisting of 31 strands 5. In addition, and as usual, spacer elements are provided between the strands 5. Each strand 5 is made up of 85 rods 7, which in turn constitute the individual load-carrying elements. This circumstance that all the strands 5 have the same dimension and construction simplifies the design of the end termination 15 and the assembly thereof. The further description of FIG. 24 refers to a tension leg 10 according to FIG. 6, though the invention can easily be adapted and used for the tension leg of FIG. 1.

FIGS. 2 and 3 show the end termination 15 of the tension leg 10. The end termination 15 is designed for connection to either an anchorage point 20 on a tension leg platform or similar on the seabed. The end termination 15 comprises a terminating receiving body 16 having external connecting means for connection to the anchorage point 20. The receiving body 16 is in the form of a heavy plate having substantial thickness. A number of apertures 8 corresponding to the number of strands 5 are drilled substantially in axial direction through the receiving body 16. The strands 5 are passed into and partially through the receiving body 16 and terminate here. How the strands 5 interact with the receiving body 16 will be more fully described with relation to FIG. 4.

At the opposite end of the end termination 15 and spaced apart from the receiving body 16, an embracing element 17 is provided The embracing element 17 is in the form of a gathering sleeve that embraces and collects the strands 5 of the tension leg 10. Between the embracing element 17 and the receiving body 16, an outer sleeve 18 is arranged. The outer sleeve 18 connects the embracing element 17 and the receiving body 16 to a bending stiff and rotary stiff unit.

In the entire longitudinal extension of the tension leg 10 the strands 5 are twisted (laid) by a predetermined laying length about the longitudinal axis of the tension leg 10. By “laying length” is meant the number of revolutions about the longitudinal axis per length unit For the illustrated tension leg 10 typical values will be like one revolution per 8 meters. The individual rods 7 within each strand 5 are in turn twisted about the longitudinal axis of the strand 5 in the same way as in a wire rope. The laying length for the rods 7 is typically 4 meters.

The embracing element 17 has an internal surface 17a formed as a flared funnel facing towards the tension leg 10 proper. The internal surface 17a may have a radius of curvature of 10 meters as an example. It can be larger or smaller depending on the detail of construction. This curvature shall provide for that the tension leg 10 receives a controlled bending against the internal surface 17a of the embracing element 17 if the tension leg 10 is exposed to a lateral force. Such a lateral force will always arise because a flexible element in the tension leg connector proper is attempting to prevent lateral motion when the tension leg 10 adopts an inclined position during lateral displacement of the platform.

When the individual strands 5 pass out of the embracing element 17 in a direction toward the receiving body 16, the strands 5 will be without any radial restriction and adopt a substantially natural direction toward and into the apertures 8 in the receiving body 16. This natural direction implies that the twisted configuration of the strands 5 ceases and transforms to a rectilinear configuration. However, the direction of each strand 5 will extend obliquely to the longitudinal axis of the tension leg 10. Said in a different way, the strands 5 extend toward the receiving body 16 by a direction that extends tangential to the helical line of the strands 5 in the tension leg 10. And, to be noticed, in addition to this oblique direction, the strands 5 will simultaneously diverge from the longitudinal axis of the tension leg 10. This direction of the strands 5 is quite naturally adopted as a consequence of that the gathering and twisting cease at the exit from the embracing element 17.

Reference is now made to FIG. 4. The receiving body 16 has as mentioned a number of apertures 8, corresponding to the number of strands 5 drilled or formed substantially axially therethrough. Each strand 5 is passed through respective aperture 8 and one terminating sleeve 9, with a diameter larger than a corresponding aperture 8 in the receiving body 16, encloses and is fixed to the free end of the strand 5. The terminating sleeve 9 will normally be formed with an internal through-going hole 9a and the lower end thereof abuts the receiving body 16. Each terminating sleeve 9 rests loosely on the receiving body 16 when the tension leg 10 is not loaded With advantage are respective recesses 12 formed in the receiving body 16 and are concentric to the respective apertures 8 of the body 16. Thus it is to be understood that the recesses 12 form guides and seats for the terminating sleeves 9 when the strands 5 are loaded.

As introductorily mentioned, during reeling of the tension leg 10 (for transportation purposes) a mutual displacement between the strands 5 will take place. This leads to that some of the strands 5 at the end termination tend to be pulled into the tension leg 10, while others are pushed out. As mentioned, this may provide undue compression stresses within the composite material for those strands 5 that are pushed out if this motion is prevented. This is solved in that the termination sleeves 9 are enabled to be displaced a distance A out of the receiving body 16. The distance A is selected somewhat longer than expected actual displacement of the strands 5 during reeling. The recesses 12 have a depth B that is chosen to be longer than the distance A. This because the terminating sleeves 9 shall not be able to be displaced completely out of the recesses 12 and in such a way that they are guided back to abutment in same seat when the strands 5 are loaded.

The final fixation of the strands 5 to the respective terminating sleeves 9 is typically made by gluing, i.e. that a liquid epoxy is poured into the holes 9a and around the strands 5 and are set to cure. The holes 9a may have any suitable form and will normally be tapered downwards, preferably conical or substantially conical. An assumed in particular favourable form of the holes 9a will be a downward directed progressive taper, i.e. that the longitudinal sectional profile of a hole 9a describes a (slight) curve or has a radius. During load the cured epoxy cone having the embedded strand ends are pulled further into the conical holes 9a A high hydrostatic pressure is created which further locks the strands 5 against slipping out of the sleeves 9.

The individual rods 7 in a strand 5 can conveniently, when they enter into a hole 9a in the terminating sleeve 9, be let loose so that they spread out, though modest, in this area. Thus the liquid epoxy will also fill out the space between the spread out rods 7 and the wedging action and the fixation within the conical holes 9a will be further improved.

Since the rods 7 are moulded or glued fixedly into the terminating sleeve 9, the transition between glued and not glued area is very vulnerable to lateral forces. In order to remedy this situation, guiding sleeves 11 for the strands 5 are provided in each aperture 8 in the receiving body 16. Thus the receiving body 16 also acts as a collecting element and replaces per se the gland 19 of the NO 20006643 reference. The length of the guiding sleeves 11 can vary and be adapted to the different applications.

The receiving body 16 including the guiding sleeves 11 are accurate positioned with respect to the embracing element 17 by means of fixation to the outer sleeve 18. Thus it is to be understood that the sleeve 18 locks the receiving body 16 and the embracing element 17 in mutual fixed position. This contributes to that the strands 5 arrive straight into the apertures 8, more precisely the guiding sleeves 11, in the receiving body 16 and pass further on straight into the holes 9a in the terminating sleeves 9 lateral forces in the vulnerable area where the glue terminates is avoided. An angular deviation of 1°, as example, where the strands 5 enter into the guiding sleeve 11 can be anticipated. The holes 9a in the guiding sleeves 11 will thus preferably be designed as a flared funnel facing towards the embracing element 17 and has a typical radius of curvature of approx. 10 meters. This implies that a controlled bending load in the strands 5 is achieved.

With advantage the apertures 8 in the receiving body 16 can be somewhat inclined relative to the longitudinal axis of the tension leg 10, and this inclined position must then correspond with that direction the strands 5 have towards the receiving body 16.

FIG. 4 also shows in closer detail a coupling for use between the end termination 15 and a connecting point 20 (anchor point). The receiving body 16 has on the outer surface thereof connecting means, here as an example shown in the form of three annular grooves 16a for interaction with three first annular ribs 21a on a connecting part 21 connected to the connecting point 20.

The connecting part 21 can be made up of two, three, four or more segments that surround the receiving body 16 and the connecting point 20. Correspondingly the connecting point 20 has three external annular grooves 20a for engagement with three second annular ribs 21b provided on the connecting part 21 at a distance apart from the three first ribs 21a, the segmented connecting part 21 being radially fixed by an upper and lower surrounding, continuous connecting part 22a, 22b.

An upper radially outer surface 21c on the connecting part 21 has an upward directed conical form and a radially inner surface 22c on the surrounding upper connecting part 22a has a complementary conical form. A lower radially outer surface 21d on the connecting part 21 has an upward directed conical form and a radially inner surface 22d on the surrounding lower connecting part 22b has a complementary conical form. The connecting part 21 may include respective upper and lower pin bolts 23a, 23b for temporary fixation of the individual segments of the connecting part 21 to the connecting point 20 and the receiving body 16 respectively.

Further, a mechanical protective cap 25 is arranged over and around the terminating sleeves 9. The cap is fixed to the receiving body 16 by means of a number of threaded connections 27.

During assembly of the connector the receiving body 16, including installed cap 25, is firstly placed against the connecting point 20. Then the individual segments of the connecting part 21 are brought against the receiving body 16 and the connecting point 20 such that the ribs 21a and 21b on the connecting part 21 engage the grooves 16a and 20a on the receiving body 16 and the connecting point 20 respectively. Each segment of the connecting part 21 is secured by the respective pin bolts 23a, 23b to the connecting point 20 and the receiving body 16.

Then the lower surrounding connecting part 22b is placed over the connecting part 21 so that their respective conical surfaces 21d, 22d touch each other. Next, the lower surrounding connecting part 22b is axially tightened by means of a number of bolts 24 that are circumferentially positioned around the lower surface of the lower connecting part 22b. The bolts 24 extend upward into threaded holes in the lower surrounding connecting part 22b. Tightening of the bolts 24 cause wedging action between the conical surface 22d of the lower surrounding connecting part 22b and the lower conical surface 21d of the connecting part 21. Thus the connecting part 21 having the ribs 21a is urged to secure fixed engagement with the grooves 16a in the receiving body 16 and forms a fixed connection therebetween.

Next, the upper surrounding connecting part 22a is put over the connecting part 21 such that their respective conical surfaces 21c, 22c touch each other. Similar to the lower connecting part 22b, the tightening of a upper set of bolts 26 will cause wedging action between the conical surface 22c of the surrounding connecting part 22a and the conical surface 21c of the connecting part 21. Thus the connecting part 21 having the ribs 21b is urged to secure fixed engagement with the grooves 20a of the connecting point 20 and forms a fixed connection therebetween.

FIGS. 5A and 5B illustrate, viewed from above and below, the end termination of a bundle of strands 5 having respective terminating sleeves 9 as it appears when free standing, i.e. without the receiving body 16 installed.

1. An end termination means for tension legs (10; 10′) of non-metallic materials like composite material, which tension leg (10; 10′) is constructed of a number of strands (5;5′, 6) that constitute the load carrying elements of the tension leg (10; 10′), which strands (5;5′, 6) are twisted (laid) about the longitudinal axis of the tension leg (10; 10′) by a predetermined laying length and each strand (5;5′, 6) is in turn constructed of a plurality of rods (7;7′) of composite material having embedded strength fibres where the rods (7;7′) are twisted about each other like in a wire rope, and the strands (5;5′, 6) terminate near a receiving body (16) having connecting means and a number of through-going apertures enclosing the respective strands, characterized in that each strand (5;5′, 6) is passed through respective aperture (8) in the receiving body (16) without being fixed therein, that each strand (5;5′, 6) has a free end terminating some distance above the receiving body (16), and that the free end of each strand (5;5′, 6) is fixed to and enclosed by a terminating sleeve (9) having a diameter larger than a corresponding aperture (8) in the receiving body (16), which terminating sleeve (9) is loosely resting on or abutting the receiving body (16).

2. The end termination means according to claim 1, characterised in that the terminating sleeve (9) is internally tapered in a direction towards the receiving body (16).

3. The end termination means according to claim 1 or 2, characterised in that a guiding sleeve (11) is arranged within each aperture (8) of the receiving body (16).

4. The end termination means according to claim 3, characterised in that the guiding sleeve (11) is shorter than the length of the aperture (8) of the receiving body (16).

5. The end termination means according to claim 4, characterised in that the guiding sleeve (11) is arranged within the aperture (8) close to the entrance of the strands (5;5′, 6) into the receiving body (16).

6. The end termination means according to 1, characterised in that each aperture (8) through the receiving body (16) terminates in a concentric recess (12) for receipt of and to act as a guide and seat for the terminating sleeve (9).

7. The end termination means according to claim 6, characterized in that each recess (12) has a depth (B) that is longer than the distance (A) that a terminating sleeve (9) is able to move out of the receiving body (16).

8. The end termination means according to 1, characterised in that the end termination (15) comprises an embracing element (17) that is spaced apart from the receiving body (16) and keeps the strands (5;5′, 6) together, that between the embracing element (17) and the receiving body (16) the strands (5;5′, 6) extend less radial restriction and in a substantially natural direction towards and into the apertures (8) of the receiving body (16).

9. The end termination means according to claim 8, characterized in that the receiving body (16) acts as a gathering element for the strands (5;5′, 6) between the embracing element (17) and the terminating sleeve (9).

10. The end termination means according to 1, characterized in that the apertures (8) of the receiving body (16) are somewhat inclined relative to the longitudinal axis of the tension leg (10) and the inclination corresponds to the natural direction of the strands (5;5′, 6) between the embracing element (17) and the terminating sleeves (9).

11. The end termination means according to 1, characterised in that the end termination (15) comprises an external rigid sleeve (18) fixed at one end thereof to the receiving body (16) and in its other end to the embracing element (17).

12. The end termination means according to 1, characterised in that the receiving body (16) on its external surface has at least one annular groove (16a) for engagement with at least one first annular rib (21a) on a connecting part (21) that is connected to a connecting point (20).

13. A coupling for use between an end termination and a connecting point according to claim 12, characterised in that the connecting point (20) has at least one external annular groove (20a) for engagement with at least one second annular rib (21b) arranged on the connecting part (21) a distance apart from the at least one first rib (21a), which connecting part (21) is radially fixed by an upper and lower embracing connecting part (22a, 22b).

14. A coupling for use between an end termination and a connecting point according to claim 13, characterised in that an upper and lower radially outer surface (21c, 21d) on the connecting part (21) has an upward directed conical form and an upper and lower radially inner surface (22c, 22d) on the respective embracing connecting parts (22a, 22b) has complementary conical form.

15. A coupling according to claim 13 or 14, characterised in that the connecting parts (20a, 22b) comprise respective pin screws (23a, 23b) for temporary fixation of the connecting parts (22a, 22b) to the connecting point (20) and the receiving body (16) respectively.
